(19) United States
(12) Patent Application Publication
(10) Pub. No.: US 2014/0371347 A1
(43) Pub. Date: Dec. 18, 2014

(54) FRICTION MATERIAL

(71) Applicant: ADVICS CO., LTD., kariya-shi, Aichi (JP)

(72) Inventors: Katsuya Okayama, Kariya-shi (JP); Masaaki Kobayashi, Kariya-shi (JP); Hiroya Kishimoto, Kariya-shi (JP); Kenichi Hiratsuka, Narashino-shi (JP)

(21) Appl. No.: 14/360,501

(22) PCT Filed: Nov. 26, 2012
(86) PCT No.: PCT/JP2012/080455

§ 371 Date: May 23, 2014

(30) Foreign Application Priority Data
Nov. 25, 2011 (JP) 2011-258330

(51) Int. Cl. C08L 61/06

(52) U.S. Cl. CPC C08L 61/06; C08L 2205/16
USPC 523/156

(57) ABSTRACT

The present invention provides a friction material having compatibility between a high effectiveness and a long life. For that purpose, a titanate compound and a cerium oxide are contained in the friction material, wherein the cerium oxide has an average particle size of 1 μm or less.

### TECHNICAL FIELD

The present invention relates to a friction material used in brakes and such like on vehicles and the like.

### BACKGROUND ART

Conventionally, compatibility between a high effectiveness (a high friction coefficient) and a long life (a high resistance to wear) has been required of a friction material used in brake pads or brake shoes on vehicles and the like. Especially in recent years, these features of the friction material have been increasingly required with the spread of large automobiles (minivans) or with size and weight reductions of brake systems.

As an example of this kind, a friction material, which is made by combining a fibrous base material and a friction modifier with thermosetting resins, and to which a rare-earth oxide having an average particle size of 2 to 20 μm was added as a part of the friction modifier in a range of 1 to 20% by volume with respect to the total amount of the friction material, is suggested (e.g., see Patent Document 1). In this friction material, the damage level to an opposing material (a rotor) is suppressed because the Mohs hardness of the rare-earth oxide used as an abrasive material is 6 and the hardness thereof is lower than that of a conventionally frequently used abrasive material, which has a Mohs hardness of 7 or more.

### CITATION LIST

### Patent Document

Patent Document 1: Japanese Patent No. 3509307

### SUMMARY OF INVENTION

### Technical Problem

In the friction material described in Patent Document 1, however, suitable conditions were set with respect to the hardness, particle size, and amount of the abrasive material added but were inadequate in terms of compatibility between a high effectiveness (a high friction coefficient) and a long life (a high resistance to wear), and further improvement of the performance was required.

The present invention was made in view of the problems described above, and it is an object thereof to provide a friction material having compatiblity between a high effectiveness and a long life.

### Solution to Problem

Generally, examples of a friction state between a friction material and an opposing material include an abrasive friction, which is a friction state caused by scratches made by the friction material on the opposing material and a adhesive friction, which is a friction state caused by a transfer to the opposing material and a shear fracture of a coating made of friction products formed on the surface of the friction material. In the abrasive friction, the surface of the opposing material is always scraped off, while in the adhesive friction, the coating formed can protect the friction surface, but effectiveness is lowered easily.

In these circumstances, the inventors of the present invention focused on the adhesive friction in terms of a long life in which the coating could protect the friction surface, and investigated and analyzed a formation process of the coating formed on the friction material and a state of the coating texture. As a result, the inventors of the present invention found that the coating formed on the surface of the friction material has a fine texture and can decrease the amount of wear without lowering the effectiveness of the friction material by adding chemically stable minute metal oxides in advance to the friction material on which the coating made of the friction products may be formed. The present invention was thus achieved.

Namely, the first characteristic configuration of the friction material according to the present invention to achieve the object described above is a friction material comprising a titanate compound and a cerium oxide, wherein the cerium oxide has an average particle size of 1 μm or less.

As in the present configuration, a titanate compound is contained in the friction material so that the coating made by friction against the opposing material can be formed on the surface thereof. And a cerium oxide having an average particle size of 1 μm or less is contained as a chemically stable metal oxide in the friction material together with the titanate compound so that the coating formed on the surface of the friction material can have a fine texture. The friction material according to the present configuration, therefore, can realize compatibility between a high effectiveness (a high friction coefficient) and a long life (a high resistance to wear).

The second characteristic configuration of the friction material according to the present invention is a friction material wherein the cerium oxide is contained in a range of 1 to 15% by volume.

As in the present configuration, a cerium oxide is contained in the friction material in a range of 1 to 15% by volume so that the texture of the coating formed can become finer. A high effectiveness and a long life, therefore, are compatible at a higher level.

The third characteristic configuration of the friction material according to the present invention is a friction material wherein the titanate compound is contained in a range of 3 to 20% by volume.

As in the present configuration, a titanate compound is contained in the friction material in a range of 3 to 20% by volume so that a coating formed can be relatively hard to come off, and the coating itself can be easily formed.

### DESCRIPTION OF EMBODIMENTS

A friction material according to the present invention contains a titanate compound and a cerium oxide, in which the cerium oxide has an average particle size of 1 μm or less. This friction material makes a high effectiveness and a long life compatible.

There is no particular limitation on the titanate compound to be contained in the friction material. Examples thereof include alkali metal titanate compound, alkali metal titanate and Group 2 elements, such as lithium titanate, sodium titanate, potassium titanate, and magnesium potassium titanate. The titanate compound is preferably contained in a range of 3 to 20% by volume, more preferably in a range of 8 to 20% by volume, with respect to the friction material. This allows the coating formed on the surface of the friction material to be relatively hard to come off, and the coating itself to be easily formed.

A cerium oxide having an average particle size of 1 μm or less is used as the cerium oxide to be contained in the friction material. When the cerium oxide added to the friction material has an average particle size of more than 1 μm, formation and micronization of the coating on the surface of the friction material is inhibited, and a friction state of this friction material is an abrasive friction. Therefore, the damage level of the friction material to the opposing material increases, and especially the life (resistance to wear) of the friction material is shortened. There is no particular limitation on the average particle size of the cerium oxide, as long as it is 1 μm or less. The cerium oxide, however, preferably has an average size of 0.4 μm or more because it has a high cost and pad moldability is aggravated if the size is too small.

There is no particular limitation on the cerium oxide, but it is preferably contained, for example, in a range of 1 to 25% by volume with respect to the friction material. If the ratio of the cerium oxide contained is too low, it is difficult to micronize the coating texture because the cerium oxide has less effect. On the other hand, if the ratio of the cerium oxide contained is too high, it is difficult to form the coating, and the friction state of the friction material has a tendency to be an abrasive friction. In these terms, the cerium oxide is preferably contained in a range of 1 to 15% by volume with respect to the friction material.

There is no particular limitation on other materials configuring the friction material according to the present invention. Materials commonly used for a friction material, for example, fibrous base materials such as metal fiber, inorganic fiber, and organic fiber; base materials such as metal chips; filling materials; and binding materials can be applied thereto. Examples of the metal fiber include copper, brass, and iron. Examples of the inorganic fiber include glass fiber and ceramics fiber. Examples of the organic fiber include aramid fiber. Examples of the filling materials include organic filling materials such as cashew dust; inorganic filling materials such as zirconium silicate, mica, barium sulfate, antimony sulfate, calcium hydroxide, and graphite; and metal powder. Examples of the binding materials include thermosetting resins such as phenolic resin, melamine resin, and epoxy resin.

### EXAMPLES

Hereinafter, the present invention will be described in more detail by showing examples of a friction material according to the present invention, but the present invention is not limited to these examples.

Friction materials manufactured using the raw materials and the formulations shown as Examples 1 to 6 and Comparative Examples 1 to 6 in Tables 1 and 2 were used for brake pads to investigate the pad moldability, the driving simulation wear test, the damage level to a rotor at low contact pressures, and the fineness of a coating when conditions including a particle size and the mixing ratio (adjusted depending on a ratio to barium sulfate) of cerium oxide (CeO₂) were varied.

The pad moldability was evaluated according to the following criteria.

◯: good, Δ: usable, x: unfavorable.

As a driving simulation wear test, a test using bench test equipment simulating urban driving in Los Angeles (L.A.) (known as LACT simulation test) was performed, and an estimated pad life (correlating with the amount of wear of the pad) (km), an average friction coefficient, and the amount of wear of a rotor (g) were investigated. The evaluation was performed according to the following criteria herein.

Estimated Pad Life

◯: 22000 km or more, Δ: 20000 km or more but less than 22000 km, x: less than 20000 km.

Average Friction Coefficient

◯: 0.41 or more, Δ: 0.39 or more but less than 0.41, x: less than 0.39.

Amount of Wear of a Rotor

◯: less than 5 g, Δ: 5 g or more but less than 10 g, x: 10 g or more.

Moreover, in order to investigate the damage level to a rotor at low contact pressures, a friction material was pressed against and braked an opposing material (a cast iron disk rotor) at a low contact pressure (0.5 MPa) according to JASO C406, and the amount of wear of the opposing material after the braking tests was measured. The amount of wear was calculated and evaluated according to the following criteria.

Amount of Wear of a Rotor at Low Contact Pressures

◯: less than 6 μm, Δ: 6 μm or more but less than 10 μm, x: 10 μm or more.

Furthermore, the fineness of a coating was investigated as follows. Samples were cut out of the friction surface of a friction material. After precision machine polishing and ion milling was performed on the samples, cross sections thereof were observed using a scanning electron microscope (SEM). The fineness of a coating was evaluated according to the following criteria.

x: more grain boundaries of a coating with respect to the predetermined criterion, ◯: fewer grain boundaries of a coating with respect to the predetermined criterion.

TABLE 1

| Formulation (% by volume) | | | Ex. 1 | Ex. 2 | Ex. 3 | Ex. 4 | Ex. 5 | Ex. 6 |
|---|---|---|---|---|---|---|---|---|
| Fibrous base | Copper fiber (Cu—F 60-3) | | 8 | 8 | 8 | 8 | 8 | 8 |
| material | Aramid fiber (TWARON 1095) | | 10 | 10 | 10 | 10 | 10 | 10 |
| Filling material | Cerium oxide | Average particle size 0.3 μm | — | — | — | — | — | 5 |
| | | Average particle size 0.4 μm | — | — | — | — | 5 | — |
| | | Average particle size 1.0 μm | 1 | 5 | 15 | 25 | — | — |
| | | Average particle size 1.2 μm | — | — | — | — | — | — |
| | | Average particle size 1.5 μm | — | — | — | — | — | — |
| | | Average particle size 5.0 μm | — | — | — | — | — | — |

| | | | | | | | |
|---|---|---|---|---|---|---|---|
| | Zirconium silicate (MZ-1000B) | 3 | 3 | 3 | 3 | 3 | 3 |
| | Titanate compound (Potassium titanate TXAX-A) | 8 | 8 | 8 | 8 | 8 | 8 |
| | Mica (B-102) | 8 | 8 | 8 | 8 | 8 | 8 |
| | Cashew dust (FF-2080) | 8 | 8 | 8 | 8 | 8 | 8 |
| | Barium sulfate (BA) | 25 | 21 | 11 | 1 | 21 | 21 |
| | Calcium hydroxide (special grade) | 3 | 3 | 3 | 3 | 3 | 3 |
| | Graphite (PAG-5) | 6 | 6 | 6 | 6 | 6 | 6 |
| Binding material | Phenolic resin powder (PR-54364) | 20 | 20 | 20 | 20 | 20 | 20 |

| | | | | | | |
|---|---|---|---|---|---|---|
| Total | 100 | 100 | 100 | 100 | 100 | 100 |

TABLE 2

| | | | Com. | Com. | Com. | Com. | Com. | Com. |
|---|---|---|---|---|---|---|---|---|
| Formulation (% by volume) | | | Ex. 1 | Ex. 2 | Ex. 3 | Ex. 4 | Ex. 5 | Ex. 6 |
| Fibrous base | Copper fiber (Cu—F 60-3) | | 8 | 8 | 8 | 8 | 8 | 8 |
| material | Aramid fiber (TWARON 1095) | | 10 | 10 | 10 | 10 | 10 | 10 |
| Filling material | Cerium oxide | Average particle size 0.3 μm | — | — | — | — | — | — |
| | | Average particle size 0.4 μm | — | — | — | — | — | — |
| | | Average particle size 1.0 μm | — | — | — | — | — | 5 |
| | | Average particle size 1.2 μm | — | 5 | — | — | — | — |
| | | Average particle size 1.5 μm | — | — | 5 | — | — | — |
| | | Average particle size 5.0 μm | — | — | — | 5 | 15 | — |

| | | | | | | | |
|---|---|---|---|---|---|---|---|
| | Zirconium silicate (MZ-1000B) | 3 | 3 | 3 | 3 | 3 | 3 |
| | Titanate compound (Potassium titanate TXAX-A) | 8 | 8 | 8 | 8 | 8 | — |
| | Mica (B-102) | 8 | 8 | 8 | 8 | 8 | 8 |
| | Cashew dust (FF-2080) | 8 | 8 | 8 | 8 | 8 | 8 |
| | Barium sulfate (BA) | 26 | 21 | 21 | 21 | 11 | 29 |
| | Calcium hydroxide (special grade) | 3 | 3 | 3 | 3 | 3 | 3 |
| | Graphite (PAG-5) | 6 | 6 | 6 | 6 | 6 | 6 |
| Binding material | Phenolic resin powder (PR-54364) | 20 | 20 | 20 | 20 | 20 | 20 |

| | | | | | | |
|---|---|---|---|---|---|---|
| Total | 100 | 100 | 100 | 100 | 100 | 100 |

As a result, as shown in Table 3, the result of any test of Examples 1 to 6 is not less than Δ, and it is found that all of Examples 1 to 6 have compatiblity between a high effectiveness and a long life. In contrast, as shown in Table 4, at least one of the test items is x in Comparative Examples 1 to 6, and none of Comparative Examples 1 to 6 have compatibility between a high effectiveness and a long life. Especially, from the result of Comparative Example 6, it is found that a good performance cannot be achieved when no titanate compound is contained in the friction material even if the cerium oxide having an average particle size of 1 μm is contained therein.

Moreover, the pad moldability has a tendency to be lowered when the average particle size of the cerium oxide is smaller or the mixing ratio of the cerium oxide is higher.

With respect to the fineness of the coating formed on the friction surface of the friction material, it is confirmed that the coating contains a small quantity of grain boundaries and is fine in all of the examples.

As described above, it is found that brake pads according to the present examples can be durable without lowering an effectiveness by using a friction material containing a cerium oxide having an average particle size of 0.3 to 1.0 μm in a range of 1 to 25% by volume with respect to the friction material together with a titanate compound. And it is found that the performance thereof is especially good when the cerium oxide having an average particle size of 0.4 to 1.0 μm is contained in a range of 1 to 15% by volume with respect to the friction material.

TABLE 3

| Test item | | Ex. 1 | Ex. 2 | Ex. 3 | Ex. 4 | Ex. 5 | Ex. 6 |
|---|---|---|---|---|---|---|---|
| Pad Moldability | | ∘ | ∘ | ∘ | Δ | ∘ | Δ |
| Driving simulation wear | Estimated pad life [km] | 22305 | 31025 | 25217 | 20822 | 31073 | 30354 |
| test | Evaluation | ∘ | ∘ | ∘ | Δ | ∘ | ∘ |
| | Average friction coefficient | 0.394 | 0.416 | 0.427 | 0.436 | 0.410 | 0.411 |
| | Evaluation | Δ | ∘ | ∘ | ∘ | ∘ | ∘ |
| | Amount of wear | 1.2 | 1.0 | 1.3 | 1.7 | 1.0 | 1.0 |
| | of a rotor [g] | | | | | | |
| | Evaluation | ∘ | ∘ | ∘ | ∘ | ∘ | ∘ |
| Damage level to a rotor at | Amount of wear | 4.9 | 3.8 | 5.1 | 9.9 | 3.7 | 3.4 |
| low contact pressures | of a rotor [μm ] | | | | | | |
| | Evaluation | ∘ | ∘ | ∘ | Δ | ∘ | ∘ |

| | | | | | | |
|---|---|---|---|---|---|---|
| Fineness of a coating | ∘ | ∘ | ∘ | ∘ | ∘ | ∘ |
| Overall evaluation | ∘ | ∘ | ∘ | Δ | ∘ | Δ |

∘: good,
Δ: usable,
x: unfavorable

TABLE 4

| | | Com. | Com. | Com. | Com. | Com. | Com |
|---|---|---|---|---|---|---|---|
| Test item | | Ex. 1 | Ex. 2 | Ex. 3 | Ex. 4 | Ex. 5 | Ex. 6 |
| Pad moldability | | ∘ | ∘ | ∘ | ∘ | ∘ | ∘ |
| Driving simulation wear | Estimated pad life [km] | 16391 | 20236 | 16620 | 12843 | 10002 | 15953 |
| test | Evaluation | x | Δ | x | x | x | x |
| | Average friction coefficient | 0.374 | 0.387 | 0.389 | 0.421 | 0.448 | 0.392 |
| | Evaluation | x | x | x | ∘ | ∘ | Δ |
| | Amount of wear | 1.5 | 1.3 | 1.5 | 2.3 | 3.2 | 1.8 |
| | of a rotor [g] | | | | | | |
| | Evaluation | ∘ | ∘ | ∘ | ∘ | ∘ | ∘ |
| Damage level to a rotor at | Amount of wear | 7.7 | 4.7 | 5.2 | 12.2 | 18.1 | 8.0 |
| low contact pressures | of a rotor [μm] | | | | | | |
| | Evaluation | Δ | ∘ | ∘ | x | x | Δ |

| | | | | | | |
|---|---|---|---|---|---|---|
| Fineness of a coating | x | x | x | x | x | x |
| Overall evaluation | x | x | x | x | x | x |

∘: good,
Δ: usable,
x: unfavorable

### INDUSTRIAL APPLICABILITY

A friction material according to the present invention can be applied to, for example, brake pads, brake shoes and such like on vehicles and the like.

1. A friction material comprising,
a titanate compound; and
a cerium oxide,
wherein the cerium oxide has an average particle size of 1 □m or less.

2. The friction material according to claim 1, wherein the cerium oxide is contained in a range of 1 to 15% by volume.

3. The friction material according to claim 1, wherein the titanate compound is contained in a range of 3 to 20% by volume.

4. The friction material according to claim 2, wherein the titanate compound is contained in a range of 3 to 20% by volume.
